(19) United States
(12) Patent Application Publication
(10) Pub. No.: US 2006/0008569 A1
(43) Pub. Date: Jan. 12, 2006

(54) Marshmallow-type adhesive food composition, and method for manufacturing same

(76) Inventors: Richard Thomas Broz, Hawthorn woods, IL (US); Mark Anthony D'Alola, Grayslake, IL (US)

Correspondence Address: Richard D. Harris, 77 W. Wacker Drive, Suite 2500, Chicago, IL, 60601, US

(21) Appl. No.: 10/886,811

(22) Filed: Jul. 7, 2004

(51) Int. Cl. A23L 1/05

(52) U.S. Cl. 426/573

(57) ABSTRACT

An edible, adhesive food composition for use in the binding of cereals or the like into bars. A method of manufacturing the adhesive food composition is also disclosed. In a preferred embodiment, the adhesive food composition has a flavor and texture reminiscent of traditional marshmallows in melted form. The food composition includes a collagen capable of forming a thermally reversible gel. When fully formed, the adhesive food composition has a bulk density significantly higher than that of traditional marshmallows.

### BACKGROUND OF THE INVENTION

1. Field of the Invention

The present invention relates in general to edible, adhesive food compositions for food products and, more particularly, to adhesive food compositions for forming relatively dry ingredients, such as ready to eat cereals, into food bars.

2. Background and the Prior Art

Food preparations comprising relatively dry ingredients, adhered together by an edible binding agent and formed into bars or the like, have been known in the art for many years. One popular form of such food preparation is crisped rice cereal bars. Traditionally, conventional marshmallows are used as the primary edible binding agent for such bars. The marshmallows are typically melted, in combination with a lipid comprising melted butter or margarine, so as to form a relatively coarse, viscous oil-in-water emulsion, which is then applied to the crisped rice in a ratio of about 2:1 by weight of emulsion to cereal.

Several difficulties have been encountered when integrating traditional marshmallows into food products. For food products requiring the inclusion of melted marshmallows, a significant amount of time, labor and space are typically expended in the melting process. Significant additional time and labor must also typically be devoted to the subsequent removal of residual melted marshmallow from the processing surfaces of the associated equipment and utensils, owing to the relatively thick viscosity and significant adhering qualities of the marshmallows in their melted state. Moreover, due in part to the typical use of whipping and/or aeration through the introduction of gasses during their manufacture, traditional marshmallows have a relatively low bulk density, generally less than thirty pounds per cubic foot. This, in turn, leads to significant expense in the transportation, storage and handling of marshmallows in their expanded form, prior to the melting process.

Jurczak et al, U.S. Pat. No. 3,682,659, discloses a spoonable marshmallow mix of relatively higher density than traditional marshmallows, using microcrystalline cellulose as a stabilizing medium, prior to the addition of a whipping agent, such as egg albumen.

Froseth, et al., U.S. Pat. No. 6,592,915, discloses layered cereal bars which, as a binder, employ a syrup composition including a gelatin mix. The gelatin mix includes a mixture of gelatin, water, fat, syrup and sugars. In one embodiment, the gelatin is not whipped, so as to avoid creating the appearance of marshmallow.

Hayward, et al., U.S. Pat. No. 4,018,900, discloses food bars having a fortified marshmallow base. A marshmallow mix, including gelatin and water, is combined with a marshmallow pre-mix, including water, preservatives, sucrose and vanilla flavoring.

Rubenstein, U.S. Pat. No. 4,189,502, discloses a marshmallow variegate for use with frozen confections, such as ice cream. An emulsifier is employed to simulate the characteristic whipped texture of traditional marshmallows, while a pre-gelatinized starch is used to simulate the stretchable nature of traditional marshmallows.

While these and other nontraditional marshmallow type items have been used in food products, it is desirable to provide an adhesive food composition which simulates the appearance, taste and texture of traditional melted marshmallows as an edible binding agent in food bars, yet has a significantly higher bulk density, yielding reduced labor, handling and storage costs.

It is also an object of the present invention to provide an adhesive food composition having a relatively low viscosity, as compared to traditional marshmallows, aiding the process of coating the cereal pieces when forming cereal bars, lubricating the cereal substrate and inhibiting its attrition, reducing the bulk density and caloric content of the finished bar, providing a sparing effect on the requirement for syrup as a binding ingredient, and requiring reduced post-process cleaning of equipment and utensils employed in the manufacturing of an associated food product.

It is a further object of the present invention to provide an adhesive food composition for food products that is relatively stable against microbial attack providing an enhanced shelf life.

It is another object of the present invention to provide an adhesive food composition having a reduced caloric content.

It is yet another object of the present invention to provide a marshmallow-type adhesive food composition that includes a thermally reversible gel for enhanced stability.

These and other desirous characteristics of the present invention will become apparent in light of the present specification, claims, and drawing.

### SUMMARY OF THE INVENTION

The present invention comprises a method for producing an edible, adhesive food composition for use in cereal bars, amongst other confections. A substantially thermally reversible gel is created by wetting at least one collagen ingredient, capable of forming a thermally reversible gel, to form an aqueous solution. At least one lipid ingredient is added to the aqueous solution. Heating and agitation is applied to the aqueous solution and lipid ingredient combination to form a pre-emulsion. The pre-emulsion is homogenized, and then cooled to permit the substantially thermally reversible gel to set.

Further, in a preferred embodiment, a hydration period is employed by waiting for the at least one collagen ingredient to become substantially hydrated within the aqueous solution. The hydrated aqueous solution is again heated. This heating is preferably performed rapidly. In a preferred embodiment, the at least one collagen ingredient comprises gelatin. Moreover, the at least one sweetening ingredient preferably comprises a substantially dry, granulated sugar. The viscous syrup preferably comprises corn syrup.

Also, in a preferred embodiment, the at least one collagen ingredient comprises a pre-blended, collagen-based mixture of substantially dry ingredients. Moreover, the substantially dry ingredients preferably include a substantially dry collagen, capable of forming the substantially thermally reversible gel. This substantially dry collagen may comprise a substantially dry gelatin.

Moreover, in a preferred embodiment, the substantially dry ingredients comprises a blend of substantially dry collagen and a substantially dry coloring additive. This substantially dry coloring additive is preferably titanium dioxide. The substantially dry ingredients may also include a bulking additive.

In a preferred embodiment, the wetting of the at least one collagen ingredient to form an aqueous solution includes the addition of water having a temperature of at least 140° Fahrenheit.

Further, in a preferred embodiment, the at least one lipid ingredient comprises margarine. Moreover, the at least one lipid ingredient may comprise a pre-blended, lipid-based mixture of at least one fat ingredient and at least one oil soluble additive. In addition, the at least one oil soluble additive may include at least one vitamin additive.

The homogenizing of the pre-emulsion is preferably performed without the introduction of significant quantities of air and other gasses into the emulsion. In a preferred embodiment, the present invention further comprises hot filling the emulsion into packages. Accordingly, the cooling of the emulsion comprises the step of rapidly cooling the emulsion and package combination. In a preferred embodiment, this cooling of the emulsion and package combination comprises rapidly cooling the combination to a temperature of not more than 110° Fahrenheit.

In one preferred embodiment of the present invention, the adhesive food composition for use in cereal bars, amongst other confections, has the following composition: about 0.1 to 10 percent by weight of at least one collagen capable of forming the thermally reversible gel; about 5 to 25 percent by weight of at least one lipid ingredient; about 0.1 to 2 percent by weight of at least one starch ingredient; and about 60 to 90 percent by weight of at least one sweetening ingredient. The collagen ingredient, lipid ingredient, starch ingredient, and sweetening ingredient collectively form the thermally reversible gel. The adhesive food composition preferably has a bulk density of approximately 90 pounds per cubic foot.

### BRIEF DESCRIPTION OF THE DRAWING

FIG. 1 is a simplified process flow diagram showing a method of manufacturing a preferred embodiment of the present edible adhesive food composition.

### DETAILED DESCRIPTION OF THE INVENTION

While this invention is susceptible of embodiment in many different forms, there are shown in the drawings and will be described in detail, several specific embodiments, with the understanding that the present disclosure is to be considered as an exemplification of the principles of the present invention and is not intended to limit the invention to the embodiments illustrated.

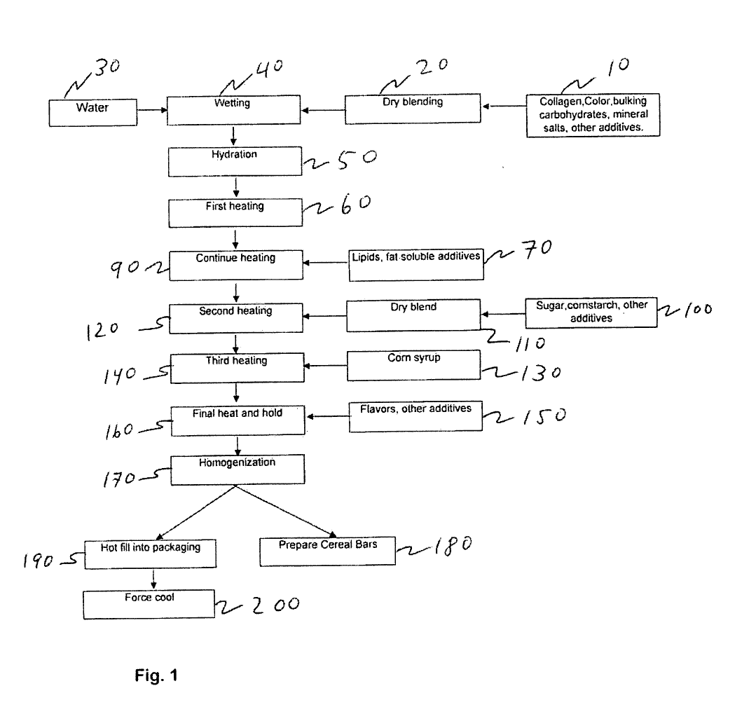

A simplified process flow diagram showing a method of manufacturing a preferred embodiment of the present marshmallow-type adhesive food composition is shown in FIG. 1. First, premix ingredients 10 are combined in dry form. At a minimum, premix ingredients 10 generally include a dry collagen, such as gelatin, as well as titanium dioxide, a preferred color additive. The dry blending step 20 of these ingredients facilitates their mutual subsequent wetting, inasmuch as titanium dioxide is a relatively dense additive and will not suspend as uniformly if added later, during the wetting process. Rather, it is preferable for the collagen and titanium dioxide to be combined in advance so as to interact during the wetting step.

In a preferred embodiment, gelatin of porcine origin is employed as the source of the collagen ingredient. Alternatively, gelatin of bovine or piscine origin may be used, as well as other suitable stabilizers. Moreover, various combinations of these collagens may be employed. As will be seen, the collagen provides the finished adhesive food composition product with structure and stabilization, through the subsequent formation of a thermally reversible gel. Other compounds other than collagen that are capable of forming thermally reversible gels, including vegetable derivatives such as agar-agar, carrageenans, and other vegetable gums which can set a thermally reversible gel, may alternatively be used. Such vegetable derivatives may be desirable, for example, when an overall food product including the present binding agent is intended to be a vegetarian, kosher or halal product.

While titanium dioxide is a preferred color ingredient, other coloring additives may alternatively be used. Yellow colors, such as beta carotene, curcumin, annatto, paprika and other natural vegetable dyes, as well as certified food colors like FD&C Yellow #5 may also be employed. Blue food dyes may also be useful at appropriate levels to enhance the white appearance of the finished adhesive food composition. When using such water dispersible colors, the collagen serves as a stabilizer, facilitating the uniform distribution of the color additive and reducing separation arising from any settling or flotation of the additive. Instead, the collagen serves to stabilize the suspension of the water dispersible color during the subsequent hydration and holding step, where no further agitation is preferably applied.

While these water soluble or water dispersible dyes are preferably incorporated into the product at wetting step 40 to assure that they are properly suspended in the aqueous solution, oil soluble dyes or food colors may also be used, either alternatively or in addition to water soluble coloring additives. As discussed further below, these oil soluble dyes are preferably added to the present adhesive food composition by preblending them with the lipid ingredients before their addition to the aqueous solution.

Premix ingredients 10 may further include additional ingredients to facilitate the subsequent wetting and hydration steps in the manufacturing process. In particular, nutritive sweeteners, other carbohydrates and/or mineral salts can be added at this time. These additional premix ingredients may act as fillers and/or bulking agents. Moreover, these ingredients may enhance the subsequent wetting process by providing further physical separation of the collagen and titanium dioxide color particles from each other during the addition of water. Further, these ingredients can provide readily water-soluble particles which dissolve fairly rapidly, permitting the spatially separated collagen and color particles, which hydrate at a much slower rate, to have a maximum surface area exposed to the water. In addition, these additional premix ingredients tend to physically separate the collagen and color particles, reducing the instances where two or more particles of collagen and color additive remain in physical contact with each other. Otherwise, a reduced portion of each particle's surface area would be exposed to water, causing, in turn, a slowing the hydration process and necessitating an increase in the required mixing energy, mixing shear and/or mixing time subsequently required for complete wetting of these powders. Instead, more complete hydration of the collagen and color additive is facilitated.

Surfactants may also be added to premix blend 10 to facilitate wetting step 40 and hydration step 50. In particular, surfactants such as mineral phosphates, silicon additives, polysorbates, food grade acidulants, and other buffers may serve to shorten the durations of wetting step 40 and/or hydration step 50.

Other potential ingredients that may be added to premix 10 at this time include smaller carbohydrates of relatively lesser molecular weight such as mono-saccharides, provided their application level does not significantly impact upon the desired osmotic pressure balance of the aqueous solution during the wetting and hydration steps. Flavorings and other functional ingredients which form thermally reversible gels, as well as other processing aids can also be incorporated into the collagen and color premix 10.

While cold water may alternatively be used for the wetting 40 and hydration 50 steps, water 30 is preferably hot, potable water of 140° Fahrenheit (F.) or greater. The use of hot water tends to accelerate the wetting and hydration of premix ingredients 10. Hot water permits enhanced activation, or hydration of the collagen and aids the speed of dissolution of any of the bulking carbohydrates, nutritive sweeteners and mineral salts by improving their respective solubility rate and permitting increased concentrations of these ingredients to be tolerated in the aqueous solution. There will, however, be a maximum temperature for water 30 beyond which the dissolution rate will become too fast, increasing the likelihood that adjacent particles of collagen and color will not be sufficiently spatially separated to prevent physical contact therebetween during the wetting process. This, in turn, will tend to cause the overall hydration time to lengthen.

A relatively high intensity mixing energy is preferably applied to the contents of the vessel during wetting step 40. Moreover, an increase in the required mixing and/or shearing energy during wetting step 40 is anticipated if the temperature of water 30 is increased significantly above about 180° F. Of course, the optimal temperature range during wetting step 40 will depend, in part, upon the specific vessel and associated equipment used for mixing, the specific quantities of ingredients mixed relative to the size of the vessel and mixing equipment, the amount of mixing energy applied, as well as the amount of shearing force delivered by the mixing equipment.

A ratio of greater than 1:1 by weight of water to solids is preferred during wetting step 40 and hydration step 50, so as to preclude a reduction in hydration rate due to low osmotic pressure. Generally, increased quantities of water, relative to solids, yield a more rapid hydration rate. A somewhat accelerated hydration rate has been observed with a water to solids ratio of approximately 1.5:1, and it is anticipated that even faster hydration rates may be achieved with yet higher water to solids ratios.

Of course, the choice of water to solids ratio during wetting step 40 and hydration step 50 can impact both the particular choice of bulking additive, as well as the desired additive quantity employed within premix ingredients 10. In general, bulking agents having molecular weights on the order of those of disaccharides and larger, and having appropriate water solubility, are preferred to smaller compounds, which tend to lessen osmotic pressure within the aqueous solution, resulting in prolonged hydration time. Sucrose and other disaccharides, alone or in combination with other larger molecular weight carbohydrate ingredients such as maltodextrins or starches, have been observed to work well, so long as proper control is exerted to prevent incorporating excess solids in wetting step 40 and hydration step 50.

Hydration step 50 is essentially a holding time, and it has been observed that it is not necessary to maintain the elevated temperature of the aqueous solution during this phase. While maintaining an elevated temperature can cause hydration to occur more quickly and, in turn, shorten the required holding time, it has been found that, if sufficient heat is delivered to the mixer by hot water 30 during wetting step 40, it is not required to insulate or prevent the cooling of the resultant aqueous solution during hydration step 50.

The actual required duration of hydration step 50 is considered to be affected by several factors, including the effectiveness of the mixing action, as delivered by the mixing equipment during wetting step 40, the quantity of mixing energy applied to the solution, and the volume of materials being mixed, relative to the size of the mixing equipment. Preferably, the quantity of the water and solid ingredients being mixed during wetting step 40 are properly proportioned, relative to the size of the associated processing equipment. Otherwise, incomplete wetting will occur, requiring increased time for hydration step 50.

Further, the temperature of water 30, and the water to solids ratio further affect the time required to provide full activation of the collagen and color additive. Using the aforementioned water temperature of approximately 140° F. to 180° F., and using a relatively moderate amount of mixing energy relative to the quantity of the volume of materials being wetted, while maintaining a water to solids ratio of approximately 1.5:1 by weight, a duration of hydration step 50 of approximately 25 minutes has been observed to work well. Longer hydration times may be employed without detriment to the resultant adhesive food composition, and shorter holding times may be achieved through compensating changes to premix ingredients 10, the associated processing equipment, as well as the temperature of water 30.

Generally, it is considered unnecessary to further stir or mix the wetted solution during hydration step 50. Nevertheless, further agitation of the wetted solution during hydration step 50 is not considered to be detrimental to the adhesive food composition, unless such agitation causes air to become entrapped within the aqueous solution. Such aeration is to be avoided, as the inclusion of gasses will reduce the specific gravity of the finished product and, in particular, the inclusion of oxygen will permit the finished product to participate in oxidation reactions. This, in turn, can adversely affect the flavor of the lipid ingredients, whose addition to the mixture is discussed in detail below. Moreover, such oxidation can result in a reduced shelf life of the finished and packaged product.

Following complete hydration, the aqueous solution is rapidly heated to a temperature of about 200° F. in first heating step 60. During this first heating, the solution is constantly stirred, preferably using a swept surface heat exchanger or other suitable cooking equipment. Since the solution is susceptible to burning and discoloration from overheating, sufficient temperature controls are desirable to preclude or limit any such burning or discoloration during first heating step 60.

Once the solution attains the desired temperature of approximately 200° F. in first heating step 60, a lipid ingredient, or lipid-based premix 70 is added to the vessel. Lipid ingredient 70 may comprise margarine, butter or other suitable food grade fat, and is added to the vessel while the mixture remains under agitation and heating. Lipid ingredient 70 will melt if it is a solid fat, or will further lose viscosity if it is an oil, and the resulting mixture will, in turn, form an unstable oil-in-water pre-emulsion. Margarine and butter are, themselves, water-in-oil emulsions, and their use as lipid ingredient 70 results in a reaction within the processing vessel, wherein there is an inversion of their emulsified state into the oil-in-water pre-emulsion state. If, however, pure fats or oils are chosen for lipid ingredient 70, no such inversion occurs, and the mixing action along with the heat serves to form the pre-emulsion. In either event, the pre-emulsion serves to facilitate the functionality of the present adhesive food composition for use within cereal bars.

Lipid premix 70 may include other ingredients, preblended into a softened or liquid state before their addition to the vessel. In particular, additives which may be difficult to incorporate earlier into the mixture, due to its heated and/or water-based nature, may instead be blended with the fat ingredient. Oil soluble dyes, as well as other oil soluble ingredients which may form large droplets instead of readily mixing into heated, aqueous solutions, are preferably added to lipid premix 70 prior to addition to the vessel. Preferably, the lipid ingredient constitutes from three to ten times the sum of the weight of all of the oil soluble additives included within lipid premix 70. The particular lipid to additive ratio may be adjusted to facilitate the subsequent dispersal of the additive or additives into the hot mixture. Some ingredients, such as oil based flavorings, colors and vitamins, are often highly difficult to incorporate into food products, and higher lipid to additive ratios may be necessary. Lower ratios may successfully be used for oil based additives that disperse more readily.

The oil-in-water nature of the mixture also facilitates the inclusion of vitamins, minerals and other nutrients, which can often be difficult to incorporate into food products. The inclusion of such ingredients in cereal bars manufactured with the present adhesive food composition are often highly desirable from consumer, marketing, and dietary health standpoints.

The addition of the unheated lipid ingredient or lipid premix 70 to the vessel causes the temperature of the resultant mixture to drop significantly. Accordingly, heating is continued, as shown in step 90 of FIG. 1. Moreover, the agitation of the mixture is continued during continued heating step 90, as the lipid ingredient or lipid premix completely liquefies or thins out and the pre-emulsion is formed. Once the pre-emulsion formation begins, sugar or a premix of sugar and other ingredients 100 are gradually added. If additional ingredients are added at this time, dry blending step 110 occurs before their addition to the vessel.

Other additives that may be included in sugar premix 100 and dry blended in step 110 can include additives which may be difficult to incorporate into a hot, beginning stage of a pre-emulsion. In particular, ingredients like corn starch do not readily mix into hot solutions that contain water without forming firm lumps that are extremely difficult to remove, and would diminish the functional properties of the finished adhesive food composition. Sugar premix 100 preferably includes other dry additives, wherein the sugar comprises approximately three to ten times the combined weight of the additional additives. The particular weight ratio may be varied, based upon the degree of difficulty of subsequently dispersing the additives into the hot pre-emulsion. For those materials that can be relatively difficult to incorporate, like hydrocolloids and other stabilizers, higher sugar to additive weight ratios will be appropriate. For less sensitive additives, lower ratios may successfully be used. In the case of the corn starch, ratios of between about 3:1 to 5:1 by weight of sugar to starch are considered to be appropriate for inclusion into the hot pre-emulsion.

Preferably, sugar 100 comprises, or sugar premix 100 includes, a dry granular sugar. These dry materials are gradually added to the mixture while heat and agitation continues to be applied. This, in turn, helps to further structure the pre-emulsion by applying abrasive energy within the vessel, due to the presence of coarse, undissolved sugar granules in intimate contact with the lipid ingredient which now exists as discrete oil droplets within the mixture. The selected granulation size of the sugar is accordingly considered important, as it provides additional energy for the construction of the pre-emulsion. Sugar that is too finely granulated, such as powdered sugar, will increase the mixing time and require the application of relatively increased shear energy to be provided by the mixing equipment. Additionally, since powdered sugar tends to dissolve faster than granulated sugar, it does not provide an equivalent abrasive energy by weight as granulated sugar. Accordingly, while powdered sugars may ultimately be used, sugars with coarser granulation such as bakers sugar, extra fine granular, and regular granulated sugar are preferred.

As the addition of the sugar or sugar premix into the hot pre-emulsion to the vessel causes the temperature of the resultant mixture to drop significantly, heating and agitation are continuously applied as sugar or sugar premix 100 dissolves and the pre-emulsion continues to be formed. To insure complete dissolution of the sugar granules, the pre-emulsion is again heated to a temperature of approximately 200° F. under continued agitation during second heating step 120. While increased temperatures will also work during heating step 120, including bringing the mixture to a boil, a temperature of about 200° F. has been observed to be sufficient.

When a temperature of about 200° F. is again reached in second heating step 120, liquid corn syrup 130 may safely be added. Although dry corn syrup may alternatively be added at this time, the inclusion of dry corn syrup would necessitate an increase in the required mixing shear forces, as well as increasing the required mixing time. Since the addition of the corn syrup again causes the temperature of the resultant mixture to drop significantly, heating and agitation are continued in third heating step 140, as the corn syrup thins out within the mixture and the pre-emulsion is completed. For third heating step 150, a temperature of at least approximately 185° F. is desirable. While increased temperatures will also work during third heating step 140, including bringing the mixture to a boil, a temperature of about 185° F. has been observed to be sufficient for this heating.

Following the attainment of the desired minimum temperature of heating step 140, additional aqueous based ingredients 150 may also be added, such as a liquid flavor, liquid color, or liquid preservatives. Any such aqueous based ingredients must be readily dispersible into the hot pre-emulsion to guarantee their uniformity of distribution under the applied heating and agitation. A final heating and holding step 160 is applied to the mixture as the additional liquid ingredients 150 are added into the pre-emulsion. Agitation is applied to completely blend and uniformly distribute these aqueous ingredients throughout the pre-emulsion.

Next, in step 170, the pre-emulsion is homogenized, preferably through the use of high pressure and without incorporating air into the pre-emulsion. Homogenization creates the final emulsion and tends to improve the shelf life of cereal bars manufactured with the present adhesive food composition. Moreover, homogenization tends to reduce the viscosity of the resultant adhesive food composition, permitting emulsion sparing, as well as overall caloric reduction of the cereal bars. During homogenization step 170, the lipid droplets within the pre-emulsion are subdivided into many discrete and much smaller droplets, which, in turn, are well dispersed in the aqueous continuous phase. High pressure homogenization is capable of providing sufficient disruptive force in a uniformly controllable manner, without any significant inclusion of air or gasses into the final emulsion. While high pressure homogenization is employed in a preferred embodiment of the present invention, other homogenization methods are also contemplated, including the use of a colloid mill, or a pin mill of the type manufactured by Ross or others. Such devices do not operate by high pressure, but instead typically apply high shearing forces or highly abrasive forces, also without the significant inclusion gases, such as air or nitrogen.

To properly attain the desired characteristics of the present adhesive food composition, several conditions are deemed necessary for homogenization step 170. First, the pre-emulsion must be warm enough to have a sufficient viscosity suitable for pumping, and to prevent the thermally reversible gel from setting up at this time, instead remaining in the sol, or suspended colloidal state. The maximum viscosity tolerated by the particular processing equipment employed within homogenization step 170 will, to some extent, affect the range of permissible temperatures of the pre-emulsion.

Second, the disruptive force applied to the pre-emulsion during homogenization must be controllable in order to generate oil droplets of a physical size and quantity such that they remain fully suspended within the continuous phase of the final emulsion. This suspension must remain until the point during cooling that the thermally reversible gel forms, and the viscosity of the present adhesive food composition increases to the point that further migration or coalescing of the oil droplets does not occur.

The inclusion of air or other gasses into the emulsion is particularly undesirable, for several reasons. Firstly, the presence of significant quantities of air or other gases reduces the specific gravity, or bulk density, of the resultant adhesive food composition and hence causes an undesirable increased bulk density in cereal bars manufactured with the adhesive food composition. This also creates a thicker emulsion viscosity, requiring increased mixing energy in the subsequent manufacture of cereal bars including the resultant adhesive food composition, which, in turn, can result in attrition of the cereal pieces.

Secondly, incorporated air includes oxygen, which, when present, is available to participate in oxidation reactions. In particular, oxidation can cause undesirable changes in the flavor of the lipid ingredient. While the present adhesive food composition, if manufactured according the process described herein, is relatively stable against microbial attack, some oxidation of the lipid ingredients may still occur over time. Moreover, protecting the lipids from subsequent oxidation can serve to prolong the shelf life of the present adhesive food composition. Accordingly, chemical preservatives such as potassium sorbate, sodium benzoate or antioxidants may be added to the present adhesive food composition to protect its flavor and color.

In addition, incorporated air or other gasses increases the required quantities of adhesive food composition that must be applied to the cereal in order to deliver an equivalent adhesive function required for the formation of the cereal into bars. Moreover, a calorie reduction in the finished cereal bars, often desirable from a marketing and consumer standpoint, is achieved through the use of a low viscosity emulsion for coating the cereal pieces, so as to reduce attrition and minimize the bulk density of the bars.

Following the completion of homogenization step 180, the resultant adhesive food composition of the present invention can immediately be used in the preparation of cereal bars, as shown in step 180 of FIG. 1. Alternatively, the adhesive food composition may be filled with sufficient heat, i.e., “hot filled”, into suitable food packaging materials, such as flexible pouches, rigid containers of glass, or other heat resistant food packages for subsequent storage at ambient conditions, as shown in step 190. The choice of packaging will, to some degree, be dictated by the intended end-user of the adhesive food composition. For commercial users, relatively large, industrial containers such as pails, drums and/or intermediate bulk containers may be employed. For consumer end-users, microwaveable containers, and/or containers which facilitate heating the emulsion through the direct immersion of the container in hot water, may be preferable. Moreover, the usage of a visually pleasing container is generally of more concern where a consumer is the end-user of the product. Consumers may, accordingly, use the present invention by simply heating such a container in a microwave or a small vessel of hot water, then coating ready to eat cereal, such as crisped rice, with the heated adhesive food composition, and finally spreading the resultant mixture into a pan to cool. Unlike traditional marshmallows, the use of such packaging facilitates the manufacture of cereal bars, by both commercial and consumer end-users, with significant labor savings, not only in the avoidance of melting the marshmallows themselves, but also the elimination of the task of cleaning the vessels and utensils normally utilized in the melting and coating processes.

Generally, the adhesive food composition is heated to temperatures of 145° F. in hot filling and packaging step 190, with temperatures over 165° F. being preferred and temperatures of 170° F. and above being considered to provide additional protection against microbial attack during storage and distribution under ambient conditions. Such thermal processing is believed to provide the resultant adhesive food composition with a microbial stability of approximately 0.675 A_{w} (water activity). To some degree, the temperature selected for hot filling and packaging will depend upon the amount of heat than can be tolerated by the chosen packaging materials receiving the adhesive food composition.

As with all prior handling of the emulsion and pre-emulsion components during its manufacture, such packaging is to be sealed in accordance with sanitary handling practices. Once sealed, the emulsion-containing packages are force cooled in step 200. Force cooling may be accomplished by conveying the packages through a cooling tunnel using water spray and/or evaporation to provide the cooling energy, by immersing the packages in a cooling bath, or in any other suitable manner to ensure a rapid decrease in temperature to a maximum temperature of about 110° F. or less. Temperatures below 110° F. are preferred, although lower temperatures may be relatively difficult to rapidly attain using traditional cooling equipment.

Depending upon the chosen hot fill packaging, the cooled packages may optionally be further grouped into multiple-unit containers, such as corrugated cartons, to facilitate their transportation, storage and handling.

In a preferred embodiment, the adhesive food composition produced by the process identified herein has the following formulation:

| Ingredient | Approximate Percentage (by weight) |
|---|---|
| Sugar | 39.84693 |
| Corn Syrup | 35.49456 |
| Margarine | 12.67589 |
| Water | 8.8763 |
| Gelatin | 1.282499 |
| Corn Starch | 1.185266 |
| Artificial Flavors | 0.2836 |
| Dextrose | 0.1207 |
| Artificial Color | 0.058 |
| Processing Aids | 0.1763 |
| Approximate Total | 100% |

Of course, variations to the above-identified formula may be applied. In particular, the collagen ingredient may vary from about 0.1% to 10% by weight of the overall product; The lipid ingredient may vary from about 5% to 25% by weight; the starch ingredient may vary from about 0.1% to 10% by weight; and the sweeteners, such as sugar and corn syrup, may each vary from about 25% to 50% by weight, and collectively vary from about 60 to 90% by weight,

The resulting adhesive food composition of the present invention, manufactured as described herein, has several significant advantages, as compared to the use of traditional marshmallows. The adhesive food composition will typically achieve a bulk density of approximately 90 pounds per cubic foot, or more than three times greater than traditional marshmallows. The resulting adhesive food composition is a tightly structured confectionary emulsion that has a relatively thin viscosity when applied, permitting a reduction in damage to the cereal substrate while providing sufficient adhesive strength for structuring the cereal into bars. The reduced air and gasses within the adhesive food composition, as compared to traditional marshmallows, provides an enhanced usable shelf life of the finished cereal bars, and permits sparing of the emulsion itself which impacts the weight of a finished cereal bar, the caloric content of the finished cereal bar, as well as the overall visual perception of quality in the finished cereal bar.

The sparing effect of the emulsion results in substantially equivalent eating qualities of finished cereal bars, compared to those prepared with traditional marshmallows, when the application rate approaches 1:1 by weight of emulsion to cereal. Further, the present adhesive food composition significantly reduces the effort required to manufacture cereal bars in the industrial/commercial, food service, and consumer environments. For the industrial/commercial and food service applications, cost savings derived from reduced labor requirements and reduced application levels provide utility beyond the reduction in caloric content attained by the use of the present invention.

Although the discussion of the present adhesive food composition has focused on its intended use with ready to eat cereals, such as crisped rice, it may also be used as an adhesive food composition for other foods, such as popcorn. Moreover, other flavorings and/or colorings may be employed, such that the adhesive food composition takes on the traditional flavor and texture of foods other than marshmallows.

The foregoing description and drawings merely explain and illustrate the invention, and the invention is not limited thereto, except insofar as the appended claims are so limited as those skilled in the art having the present disclosure before them will be able to make modifications and variations therein without departing from the scope of the invention.

What is claimed is:

1. A method for producing an edible, adhesive food composition for use in cereal bars amongst other confections, comprising the steps of:
creating a substantially thermally reversible gel by wetting at least one collagen ingredient to form an aqueous solution, the at least one collagen ingredient being capable of forming the thermally reversible gel;
adding at least one lipid ingredient to the aqueous solution;
heating and agitating the aqueous solution and lipid ingredient combination to form a pre-emulsion;
homogenizing the pre-emulsion to create a final emulsion; and
cooling the final emulsion and permitting the substantially thermally reversible gel to set.

2. The invention according to claim 1, further comprising the steps of:
waiting for the at least one collagen ingredient to become substantially hydrated within the aqueous solution; and
heating the hydrated aqueous solution.

3. The invention according to claim 2, wherein the step of heating the hydrated aqueous solution comprises the step of rapidly heating the hydrated aqueous solution.

4. The invention according to claim 1, further comprising the step of adding at least one sweetening ingredient to the pre-emulsion.

5. The invention according to claim 4 wherein the at least one sweetening ingredient comprises a substantially dry, granulated sugar.

6. The invention according to claim 1, further comprising the step of adding at least one viscous syrup to the pre-emulsion.

7. The invention according to claim 6 wherein the at least one viscous syrup comprises corn syrup.

8. The invention according to claim 1 wherein the at least one collagen ingredient comprises gelatin.

9. The invention according to claim 1 wherein the at least one collagen ingredient comprises a pre-blended, collagen-based mixture of substantially dry ingredients.

10. The invention according to claim 9 wherein the substantially dry ingredients include a substantially dry collagen, capable of forming the substantially reversible gel.

11. The invention according to claim 10 wherein the substantially dry collagen comprises substantially dry gelatin.

12. The invention according to claim 9 wherein the substantially dry ingredients comprises a blend of substantially dry collagen and a substantially dry coloring additive.

13. The invention according to claim 12 wherein the substantially dry coloring additive comprises titanium dioxide.

14. The invention according to claim 9 wherein the substantially dry ingredients include a bulking additive.

15. The invention according to claim 1 wherein the step of wetting the at least one collagen ingredient to form an aqueous solution includes the addition of water having a temperature of at least 140° Fahrenheit.

16. The invention according to claim 1 wherein the at least one lipid ingredient comprises margarine.

17. The invention according to claim 1 wherein the at least one lipid ingredient comprises a pre-blended, lipid-based mixture of at least one fat ingredient and at least one oil soluble additive.

18. The invention according to claim 17 wherein the at least one oil soluble additive includes at least one vitamin additive.

19. The invention according to claim 1 wherein the step of homogenizing the final emulsion is performed without the introduction of significant quantities of air and other gasses into the final emulsion.

20. The invention according to claim 1, further including the step of hot filling the final emulsion into a package, and wherein the step of cooling the final emulsion comprises the step of rapidly cooling the final emulsion and package combination.

21. The invention according to claim 20, wherein the step of rapidly cooling the final emulsion and package combination comprises rapidly cooling the final emulsion and package combination to a temperature of not more than 110° Fahrenheit.

22. The invention according to claim 1, further comprising the step of adding a preservative to the pre-emulsion.

23. An edible, adhesive food composition for use in cereal bars amongst other confections, said adhesive food composition comprising:
about 0.1 to 10 percent by weight of at least one collagen ingredient, the at least one collagen ingredient being capable of forming a thermally reversible gel;
about 5 to 25 percent by weight of at least one lipid ingredient;
about 0.1 to 2 percent by weight of at least one starch ingredient; and
about 60 to 90 percent by weight of at least one sweetening ingredient,
said collagen ingredient, lipid ingredient, starch ingredient and sweetening ingredient forming said thermally reversible gel.

24. The invention according to claim 23 wherein the adhesive food composition has a bulk density of about 90 pounds per cubic foot.
